(19) United States
(12) Patent Application Publication
(10) Pub. No.: US 2016/0098911 A1
(43) Pub. Date: Apr. 7, 2016

(54) SYSTEM TO DETER THE CLIMBING OF OPEN STAIRS

(71) Applicant: Richard Brian Murphy, San Diego, CA (US)

(72) Inventor: Richard Brian Murphy, San Diego, CA (US)

(21) Appl. No.: 14/874,367

(22) Filed: Oct. 2, 2015

Related U.S. Application Data
(60) Provisional application No. 62/071,821, filed on Oct. 3, 2014.

(51) Int. Cl. G08B 21/02

(52) U.S. Cl. CPC G08B 21/0261

(57) ABSTRACT

The present invention provides an apparatus to detect a person or animal climbing the outside of an open stairway said apparatus comprising a sensor to detect the presence of a person or animal on the external portion of an open stairway, a power supply and an alarm system. The present invention further provides for a means to maintain stable association of the apparatus with the stairway. The invention further provides a method of detecting a person or animal climbing the outside of an open stairway and providing an alert and/or deterrent to such activity. The present invention further comprises kits comprising one or more sensors, a power supply, an alarm system, one or more electrical connectors, one or more fastening means and instructions for use.

### CROSS-REFERENCE TO OTHER APPLICATIONS

This application is related to and claims the benefit pursuant to 35 U.S.C. 119 of U.S. Provisional Patent Application Ser. No. 62/071,821 filed Oct. 3, 2014.

### BACKGROUND OF THE INVENTION

Many homes provide open stairways, i.e. a stairway configuration where at least one side of the stairway does not terminate at a wall. It is well known that children will climb the outside of such open stairways, generally by standing on the area of the tread that protrudes beyond and/or between the balusters and assisting climbing by holding on to the balustrade. Many children are seriously injured each year by falling when engaging in this activity. While there are many devices available to prevent children from climbing the inside portion of stairways (e.g. security gates) none of these devices deter children from climbing the outside of an open stairway and/or provide an alert to caregivers of a child engaging in such activity. The present invention addresses this need.

### SUMMARY OF THE INVENTION

The present invention provides an apparatus to detect a person or animal climbing the outside of an open stairway said apparatus comprising a sensor to detect the presence of a person or animal on the external portion of an open stairway, a power supply and an alarm system. The present invention further provides for a means to maintain stable association of the apparatus with the stairway. The invention further provides a method of detecting a person or animal climbing the outside of an open stairway and providing an alert and/or deterrent to such activity. The present invention further comprises kits comprising one or more sensors, a power supply, an alarm system, one or more electrical connectors, one or more fastening means and instructions for use.

### BRIEF DESCRIPTION OF THE FIGURES

FIG. 1 is a front perspective view of one embodiment of an apparatus of the present invention wherein the sensor is configured as a pressure sensitive mat (100) illustrated in association with 3 steps of an open stairway (101) in a manner contemplated by the present invention such that the exposed surface of the OTEP is substantially covered by the pressure sensitive mat, and the pressure sensitive mat is in electrical communication (200) with a power supply (201) and an alarm system (202). The stairway (101) comprises at least one step, each step comprising a tread (102), a riser (103), and one or more balusters (104).

FIG. 2 provides an illustration of one embodiment of an apparatus of the present invention wherein the sensor is configured as a pressure sensitive mat in association with a 3 steps of a typical open stairway in a manner contemplated by the present invention. As illustrated in this FIG. 2, the pressure sensitive mat may be configured to extend beyond the OTEP area into the area between the balusters where a person may be able to place a foot to minimize the opportunity to avoid detection by the apparatus.

FIG. 3 is a flowchart illustrating the typical operation of the apparatus of the present invention. As illustrated, upon activation of the system and continuously (or periodically) during operation, the system conducts a check protocol to ensure sufficient power and electrical continuity of the system. The system then senses the presence of absence of pressure on the pressure sensitive mat. If pressure is sensed, the alarm functions of the system are activated. If not, then it goes back to repeat the cycle.

FIG. 4 is a block diagram of the electrical components of the apparatus of the present invention.

FIG. 5 is a upper perspective view of an apparatus of one embodiment of an apparatus of the present invention wherein the sensor is a proximity sensing (or diffused) photoelectric sensor provided in a sub-housing that is rotatably attached to the main housing containing the alarm system power supply, the sub-housing being connected to the main housing via a shaft, the shaft preferably being hollow to permit internal passage of the electrical wiring from the sensor to the alarm and power supply. In this embodiment, the main housing provides a recess to receive a baluster and clamping means illustrated here as knob and threaded screw clamp arrangement to provide stable association of the apparatus with the stairway. FIG. 5 also illustrates a focusing mask to restrict the field of view of the sensor to a zone close to the plane of the balusters. In FIG. 5, the mask are shown dissociated from its normal position on the front face of the sub-housing to permit illustration of the components of the sensor. Similarly, the battery door would normally be associated with the housing but is illustrated here as detached to illustrate the power supply.

FIG. 6 is a perspective view of an apparatus as described in FIG. 5 when attached to the balustrade of a stairway. The semi-transparent fan shaped

FIG. 7 is an upper perspective view of one embodiment of an apparatus of the present invention wherein the sensor is a passive infrared sensor provided in a sub-housing that is rotatably attached to the main housing containing the alarm system power supply, the sub-housing being connected to the main housing via a shaft, the shaft preferably being hollow to permit internal passage of the electrical wiring from the sensor to the alarm and power supply.

FIG. 8 is an lower perspective view of one embodiment of an apparatus of the present invention wherein the sensor is a passive infrared sensor provided in a sub-housing that is rotatably attached to the main housing containing the alarm system power supply, the sub-housing being connected to the main housing via a shaft, the shaft preferably being hollow to permit internal passage of the electrical wiring from the sensor to the alarm and power supply.

FIG. 9 is an upper perspective view of one embodiment of an apparatus of the present invention as detailed in FIGS. 7 and 8 stably illustrated in position on the balustrade, the fan shaped shaded section illustrating the fan shaped planar field of view of the PIR sensor.

### DETAILED DESCRIPTION

Detailed embodiments of the present invention are disclosed herein. However, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention. Furthermore, any section headings are merely for convenience of the reader and not intended to provide a limitation on the scope of the disclosure with respect to any feature of utility of the present invention.

The present invention provides an apparatus to detect the presence of a living being on the outside of an open stairway said apparatus comprising:
(a) a power supply,
(b) an alarm system in electrical communication with the power supply said alarm system capable of producing an alert in response to an electrical signal,
(c) one or more sensors each of said sensors configured to detect the presence of a living being on the outside of an open stairway, said sensor being in electrical communication with said power supply and said alarm system, such that when the sensor detects a living being on the outside of an open stairway an electrical signal is generated which activates the alarm system that provides an alert.
   In one embodiment of the invention, the sensor is a pressure sensor. In another embodiment of the invention, the sensor is a photoelectric sensor. In another embodiment of the invention, the sensor is a passive infrared sensor. In another embodiment of the invention, the sensor is magnetic field proximity sensor. In another embodiment of the invention, the alarm system provides a local alert. In another embodiment of the invention, the alarm system broadcasts a signal to a remotely located remote alert device.

### A. DEFINITIONS

The following terms are used in the description of the present invention:

The term “step” as used herein is composed of a tread and a riser.

The term “stairway” as used herein means a series of more than one step. As a matter of convention, the number of stairs in a stairway is measured by the number of risers, not treads. A straight stairway is a stairway that proceeds in a straight line when viewed from the centerline of the stairway and the surface of the treads are substantially rectangular in shape. A curved stairway is a stairway in which the treads are winders. A circular stairway is an example of a curved stairway.

The term “open stairway” refers to a stairway where at least one end of the step does not terminate at a wall. An open stairway may be open on one side (“single open stairway”) or on both sides (“double open stairway”).

The term “inside of an open stairway” refers to the portion of an open stairway which is conventionally used for climbing the stairs defined, in the case of single open stairways at one end by a wall and the vertical plane defined by the balusters on the other or, in the case of double open stairways, defined on each end by the vertical planes defined by the balusters.

The term “outside of an open stairway” refers to the portion of an open stairway that faces away from the inside of the open stairway. The outside of an open stairway includes the OTEP regions and the region proximal to the outer surfaces of the balustrade.

The term “tread” as used herein refers to the portion of the stairway that is stepped on. The “tread depth” is measured from the leading edge of the tread to the riser in the direction of the stairway. In the event that the stairway does not provide a riser element between each stair, the tread depth is the distance from the leading edge to the trailing edge of each tread. The “tread width” is the distance measured from one side to another including any portion that extends beyond the balusters. In some configurations, the exposed portion of the tread in an open stairway is fitted with a decorative trim piece of approximately the same cross-section as the tread (e.g., to cover the exposed end-grain of the wood of the tread) and the term tread as used herein includes any such decorative trim piece.

The terms “rise” and “rise height” are used interchangeably herein to refer to the distance between the top of one tread to the top of next higher tread in the stairway.

The terms “riser” or “riser board” are used interchangeably herein to refer to the vertical element between each tread in a stairway. In certain instances, a stairway may not provide a riser element leaving an open space between each tread.

The term “nosing” as used herein refers to the portion of the leading edge of the tread that protrudes beyond riser of the step below. Some stairways are constructed such that the leading edge of the tread is flush with the riser and such does not provide a nosing.

The term “starting step” as used herein refers to a step in a stairway that begins at the floor and ends at the first tread.

The term “stringer” as used herein refers to the structural member that supports the treads and risers.

The term “winders” is used in its conventional sense to refer to steps where the depth of the tread is unequal across the width of the tread. Winders are used to change the direction of stairs without landings and, when employed in a series, form circular stairways.

The term “balustrade” as used herein refers to the system of railings and balusters.

The term “baluster” as used herein refers to a vertical element of the balustrade that extends upward from the tread and supports the handrail. By convention when two or more balusters are used with respect to a single tread, the first baluster is the one closest to the nose edge of the tread. Additional balusters on the same tread are referred to as the “second baluster”, “third baluster” and so forth. Typically, the second or additional balusters on a given step are taller than the first baluster given the angled nature of the handrail at which the upper portion of the baluster terminates.

The term “Open Tread End Protrusion” or “OTEP” as used herein refers to the area from the outer surface of the baluster to the open end of the tread on open straight stairs. On curved stairs the term Open Tread End Protrusion or OTEP is the perpendicular distance between the midpoint of a line drawn between the centerline of the first and last baluster on a given tread and the open end of the tread. In some instances, the exposed tread of the open stair proceeds in the direction of the stairway beyond the riser leading to a protrusion beyond the riser and outside of the external stringer and the term OTEP includes this exposed portion tread as well.

The term “electrical communication” is used in its conventional sense to refer to structures capable of conducting electrical current such as wires.

The term “living being” as used herein refers to human beings and mammalian companion animals such as dogs and cats.

### B. SENSOR

The unwanted presence of a living being on the outside of an open stairway is detected via a sensor. The term “sensor” is used herein in its conventional sense to describe a device that responds to a physical stimulus (such as light, infrared energy, sound, pressure, magnetism, or a particular motion) and generates an electrical signal in response thereto. A variety of devices may be employed as sensors in the practice of the present invention including but not limited to pressure sensors, photoelectric sensors, passive infrared sensors or magnetic field proximity sensors.

1. Pressure Sensors:

In one embodiment of the apparatus of the present invention, the sensor is a pressure sensor. A pressure sensor is a device which emits an electrical impulse in response to the application of pressure. One embodiment of a pressure sensor is a pressure sensitive mat. The term “pressure sensitive mat” refers to a substantially planar tape switch that is adapted for mounting over the open end of the tread of a step of an open stairway such that the pressure sensitive mat substantially covers the exposed the flat surface of the OTEP from the outside of the stairway. By the term “substantially covers the exposed surface of the OTEP”, it is understood that when the pressure sensitive mat when mounted in position covers exposed surface area of the OTEP by about 50% or more, 70% or more, 80% or more, 90% or more, 95% or more, or 100% of the OTEP.

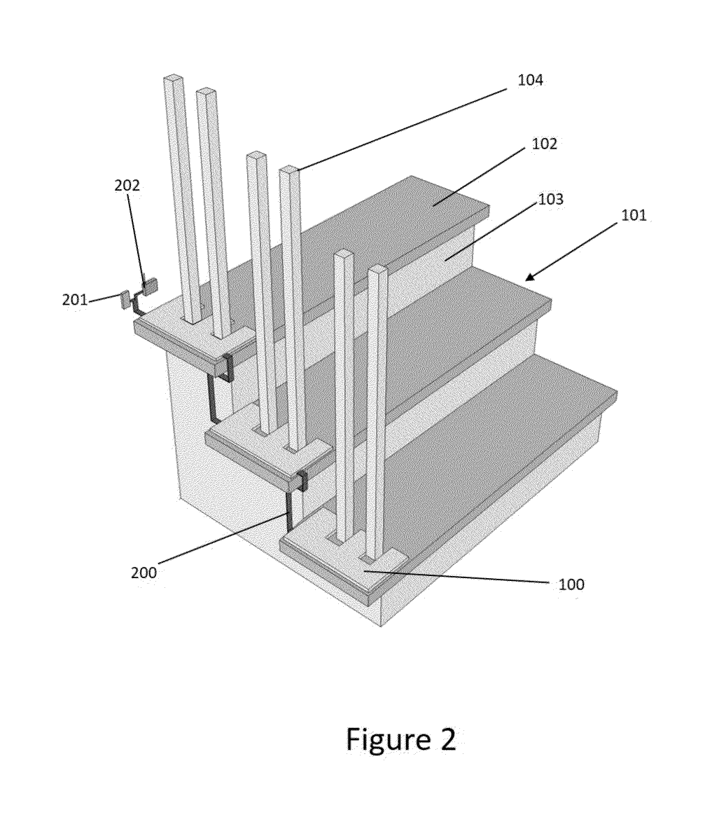

Optionally, as illustrated in this FIG. 2, in addition to covering a substantial portion of the OTEP region of the tread, the pressure sensitive mat may extend to regions of the tread between the balusters to further eliminate any region of the tread that an individual could access from the exterior of the open stairway for use as a foothold.

The pressure sensitive mat is formed of conventional tape switch materials well known to those of skill in the art. In one embodiment of the invention, the pressure sensitive mat is constructed of a tape switch material that may be cut to shape commercially available from the Tapewitch Corporation, 100 Schmitt Boulevard, Farmingdale N.Y. 11735. This facilitates the broad use of the apparatus of the present invention to any of a variety of stairway configurations.

The selection of the pressure sensitive mat material for use in the practice of the present invention will take into consideration the actuation force. The typical application of the system of the present invention is to provide an alert in response to small children from climbing the external of the stairway. The primary target population is small children that conventionally weigh less than about 40 kg. The contact surface area of a foot of a child is less than approximately 100 cm² (0.01 m²). Consequently, the pressure sensitive mat material is generally configured to have an actuation force of less than approximately 0.4 kg/cm², alternatively less than about 0.2 kg/cm², alternatively less than about 0.1 kg/cm², or alternatively less than about 0.05 kg/cm².

It will be understood by the skilled artisan that the present invention may be readily adapted to a variety of stairway configurations. However, given that current design and conventionally accepted dimensions for the construction of stairways are well established, a single design may be provided that is useful in a variety of situations. Industry standard guidelines for the construction of stairways are published by the Stairway Manufacturer's Association (657 Quarry Street, Fall River Mass. USA, www.stairways.org). Additionally the International Code Council (“ICC”) publishes standards for the construction of stairways embodied in documents such as the “2009 International Residential Code for One-and Two-Family Dwellings and 2009 International Building Code, (International Code Council, Inc., Washington, D.C., www.iccsafe.org). Such conventionally accepted design criteria will assist the skilled artisan in the design of pressure sensitive mats for use in the practice of the present invention.

The upper surface of the pressure sensor may also incorporate structural features that are commonly employed to discourage contact with human skin such as pointed structures. As will be readily apparent, when used the present invention is used to deter children climbing the outside of stairways, such structural features should be incorporated in a manner so as to discourage a child from stepping on the upper edge of the pressure sensor but not inflict bodily injury.

In some instances, the stairways may provide a “baserail” or “shoerail” that is presented at an angle substantially the same as the handrail and the balusters terminate at the lower end at this baserail. The apparatus of the present invention may be applied in this instance as well by the addition of pressure sensitive mats on the upper surface of the baserail providing an alert in the event that a child attempts to climb the outside of the stairway by putting his feet on the baserail as opposed to the OTEP.

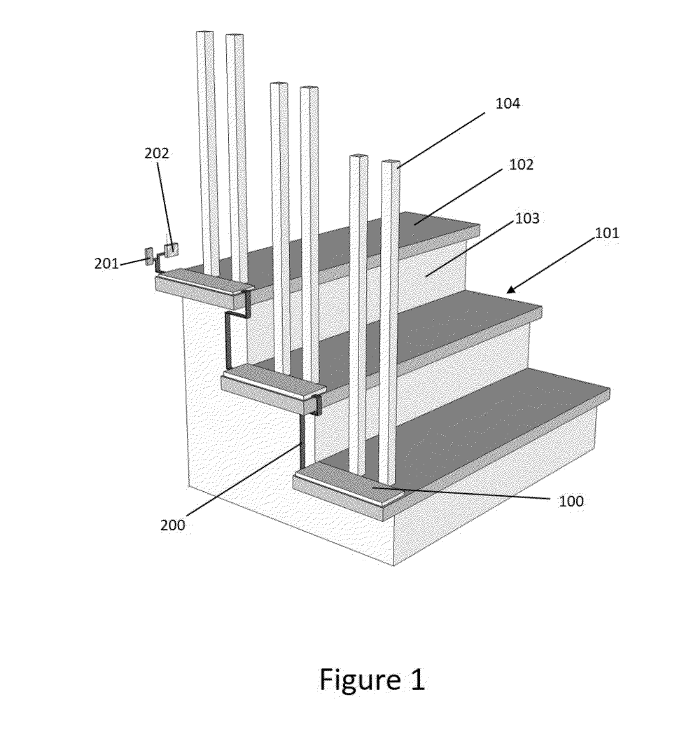

In general, a plurality of pressure sensitive mats of the present invention will be affixed to multiple of the lower steps in a stairway. The number of pressure sensitive mats to be installed will be apparent to the skilled artisan based on factors such as the size of the individual to be deterred and the rise of each step. One illustration of stairway where three pressure sensitive mats are installed on the lower steps of a conventional stairway is illustrated in FIGS. 1 and 2 of the attached drawings.

2. Photoelectric Sensors

In one embodiment of the apparatus of the present invention, the sensor is a photoelectric sensor. A photoelectric sensor is an electrical device used to detect the presence of a target object (in this instance, a living being) comprising a light emission source and a photoelectric receiver. The light emission source may emit light in the visible spectrum or light in the invisible spectrum (including infrared or ultraviolet light). The light emitted by the light emission source may be laser light. The emission source may provide light in a continuous or pulsed manner. The provision of light in a pulsed manner is preferred to minimize false positives due to variations in ambient light. The pulsed operation of the sensor and receiver may be under the control of a microprocessor programmed to process the pulsed operation. The photoelectric receiver detects changes in light energy levels and generates an electrical signal in response to variations in the light energy detected.

Photoelectric sensors used in the practice of the present invention are generally configured in one of three different arrangements: (a) “through beam”; (b) retro-reflective and (c) proximity sensing. In the “through beam” arrangement, the sensor system comprises a light emission source directed at a remotely located photoelectric receiver such that when an object is passes between the emission source and the photoelectric receiver the level of light energy contacting the photoelectric receiver is decreased and the photoelectric receiver generates an electrical signal in response thereto. In the retro-reflective arrangement the emission source and photoelectric receiver are co-located (usually in a single housing) and the light energy produced by the emission source is bounced off of a remotely located reflector back to the photoelectric detector. Similar to the through beam arrangement, when an object passes between the emission source and the reflector, the level of light energy contacting the photoelectric receiver is decreased and the photoelectric receiver generates an electrical signal in response thereto. The proximity sensing (or diffused) arrangement is similar to the retro-reflective arrangement where the emission source and photoelectric receiver are co-located (for example, in a single housing) however rather than using a reflector and detecting an interruption in the beam, the proximity sensing arrangement relies on monitoring light energy reflected from an target object passing within the field of view of the sensor. Variations in the light detected by the photoelectric receiver indicate the presence of an object within the field of view of the sensor and resulting in the generation of an electrical output signal transmitted via the electrical connections to the alarm system.

3. Passive Infrared Sensors:

In one embodiment of the apparatus of the present invention, the sensor is a passive infrared (PIR) sensor. A passive infrared sensor is an electronic sensor that detects infrared radiation within its field of view. In contrast to photoelectric sensor described above, PIR sensors do not emit light energy for detection purposes but instead detect infrared radiation emitted by (or reflected off) an object. Passive infrared sensors are well known in the art. PIR sensors are comprised of one or more thin film elements constructed of pyroelectric materials (materials that generate energy when exposed to heat such as gallium nitride, cesium nitrate) and are typically manufactured as part of an integrated circuit. A PIR sensor detects changes in the amount of infrared radiation of the objects in the field of view of the sensor. For example, when a human being comes within the field of view of the sensor the infrared heat energy produced by the human being is detected by the PIR sensor and results in a change in the output voltage which may be used to trigger an alarm system.

4. Magnetic Field Proximity Sensor:

In one embodiment of the apparatus of the present invention, the sensor is a Magnetic Field Proximity (MFP) sensor. An MPF sensor refers to an electrical device to detect the presence and/or motion of a physical object (“commonly referred to as the “target”) without physical contact by emitting an electromagnetic field and then sensing changes in the return signal. The field of view of MFP sensors may be varied through the use of a sensitivity adjustment potentiometer to modulate the sensing distance (termed “nominal range”) of a MFP sensor. MFP sensors with unshielded probes provides a wider view angle.

5. Field of View

The term “field of view” is used with respect to sensors that do not rely on contact for actuation (i.e., non-pressure sensors such as photoelectric sensors, PIR sensors and MFP sensors) to describe the three dimensional space where such sensor is capable of detecting the presence and/or movement of an object. Absent the use of devices to restrict or shape the field of view of the sensor or light beam, the field of view of a through-beam photoelectric sensor is a substantially cylindrical zone, the axis of which is defined as a line between the center of the emission source and the center of the receiver and the width of the cylinder dependent on the physical dimensions of the light emission source and/or photoelectric receiver. In the case of a retro-reflective photoelectric sensors, the field of view is two substantially cylindrical zones, the axis of one zone being defined by a line between the center of the emission source and the center of the reflector element and the axis of the second zone being defined a line between the center of the reflector element and the center of the photoelectric receiver, and the width of the cylinders dependent on the physical dimensions of the light emission source, the reflector(s) and/or photoelectric receiver.

With respect to photoelectric, passive infrared or magnetic field proximity sensors, absent the use of devices to restrict or shape the field of view of the sensor, the field of view of such sensors conform to a substantially spherical sector, the sensor face defining the apex or center of the sphere. The radius of the sphere is determined by the sensing distance or nominal range of the sensor (i.e., the distance from the front of the sensor to the object at the limit of detection). The cone angle of the spherical sector is the angle formed between the apex or center of the sphere and the center of the cap structure defined by the intersection of the cone with the surface of the sphere. The cone angle is generally one-half of the view angle of the sensor. A cone angle of 90° defines a hemispherical spherical sector. In general, the view angle of the sensor is typically expressed as twice the cone angle. For example a PIR sensor having a 110° view angle would have a cone angle of approximately 55°.

In one embodiment of the apparatus of the present invention the sensor is provided in a sub-housing that is rotatably attached to a main housing containing other elements of the apparatus including the alarm system and power supply. By providing the sensor in a rotatable sub-housing via a shaft between the main housing and the sub-housing, the field of view of the sensor may be optimized for the particular conformation of the stairway. The sensor provided in the sub-housing is in electrical communication with such the other electrical components provided in the main housing. In order to hide the wiring from sight, the shaft between the main housing and sub-housing may be hollow to allow passage of the wiring from the sensor to the other components such as the alarm system, power supply, etc.

6. Focusing Elements

Optionally, a photoelectric sensor or passive infrared sensor may be provided with one or more focusing elements that restrict the shape of the light beam emitted by the emission source and/or the field of view of the photoelectric or PIR receiver. In the context of the present invention, the photoelectric sensor is affixed to the outer portion of the stairway or balustrade and generates an alarm in response variations in light received by the photoelectric receiver in response to target objects (e.g. living beings) present on the outside of an open stairway.

It is desirable to avoid false alarms which may arise from persons or animals using the inside portion of the stairway or walking near the outside of the open stairway. Typically this is less of an issue when a through-beam or retro-reflective photoelectric sensor is employed as these typically provide a substantially “line of sight” field of view. However, when using sensor elements that have a more diffuse field of view such as photoelectric proximity sensors, PIR sensors or MFPS sensors, it may be desirable to employ the use of focusing elements to restrict the field of view of the sensor to a narrow zone close to and in a plane substantially parallel to the plane defined by the balusters to detect the presence of a living being present on the outside of an open stairway.

The focusing element may be one or more lenses placed in front of the light emission source to focus the light in a narrower path. The focusing element may be configured as a mask placed in front of the emission source providing one or more apertures that restricts the breadth of the light beam. The focusing element may be one or more lenses placed in front of the photoelectric receiver to restrict the field of view of the photoelectric receiver. The focusing element may also be a mask placed in front of the emission source providing one or more apertures that restricts the field of view of the photoelectric receiver.

Examples of focusing elements are lenses or mirrors which may be selected to provide a broad view angle, typically greater than 90° (e.g., approximately 100°, 110°, 120°, 130°, 140°, 150°, 160°, 170°, or 180°) or narrow view angle, typically greater than 90° (e.g., approximately 1°, 5°, 10°, 15°, 20°, 25°, 30°, 40°, 50°, 60°, 70°, or 80°) coverage and may be comprised of multiple elements to “shape” the field of view of the sensor.

In one embodiment, the photoelectric sensor employs one or more focusing elements to provide a substantially “fan shaped” planar field of view to the photoelectric, PIR or MFP sensor.

7. Filters:

Additionally or optionally, filters may be employed to restrict the type, frequency or wavelength of light that is allowed to pass to the sensor. Examples of filters useful in the practice of the present invention are filters which restrict the passage of visible or infrared light termed infrared transmitting filters. In one embodiment when using a PIR sensor, filter elements may be placed in front of the PIR sensor that restricts the wavelengths of infrared light available to the sensor to a particular frequency range or wavelength. In one such embodiment, the filter is a long wavelength infrared transmitting filter that restricts the passage of infrared light to a wavelength of approximately 8-14 microns (the infrared radiation typically emitted by humans). Such filter elements and materials are commercially available from suppliers such as Edmund Optics, Inc. (101 East Gloucester Pike, Barrington, N.J. 08007-1380 USA).

Particular embodiments of apparatuses of the present invention are provided in the attached drawings. The embodiments provided in the drawings are illustrative and should not be construed as limiting of the scope of present invention. Certain aspects of the apparatus illustrated in the drawings may be exaggerated for illustration purposes.

FIG. 1 of the drawings provides a front perspective view of one embodiment of the present invention wherein the sensor is a pressure sensitive mat (100) of the present invention illustrated in association with 3 steps of an open stairway (101) in a manner contemplated by the present invention such that the exposed surface of the OTEP is substantially covered by a pressure sensitive mat, the pressure sensitive mat is in electrical communication (200) with a power supply (201) and an alarm system (202). The stairway (101) comprises at least one step, each step comprising a tread (102), a riser (103), and one or more balusters (104).

FIG. 2 of the drawings provides and illustration of one embodiment of the pressure sensitive mat in association with a 3 steps of a typical open stairway in a manner contemplated by the present invention. As illustrated in this FIG. 2, the pressure sensitive mat is shaped to extend beyond the OTEP area into the area between the balusters where a person may be able to place a foot to minimizing the opportunity for a person climbing the outside of the stairway being able to avoid detection by the sensor.

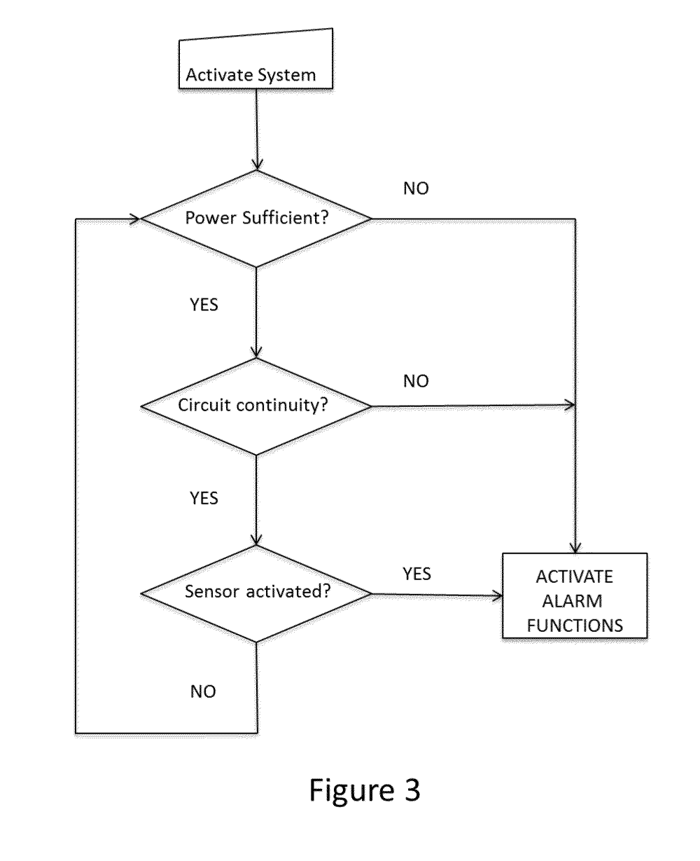

FIG. 3 of the drawings is a flowchart illustrating the typical operation of the apparatus of the present invention. As illustrated, upon activation of the system and continuously (or periodically) during operation, the system conducts a check protocol to ensure sufficient power and electrical continuity of the system. The system then senses the presence of absence of activation of the sensor. If the sensor is activated, the alarm functions of the system are activated. If not, then it goes back to repeat the cycle.

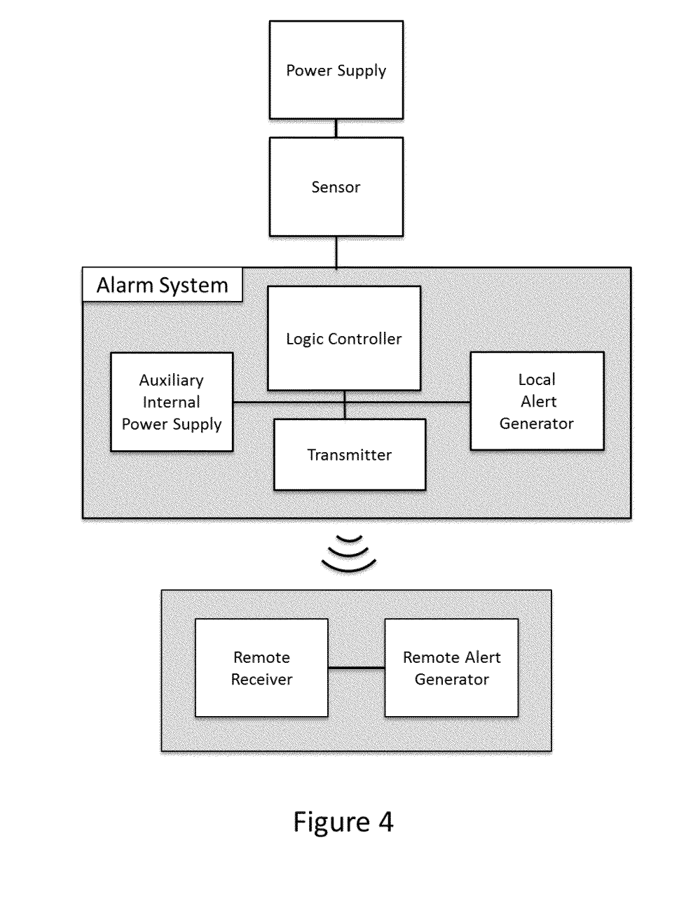

FIG. 4 of the drawings is a block diagram of the electrical components of the apparatus of the present invention incorporating a logic controller and a transmitter to a remote receiver and remote alert generator (alarm).

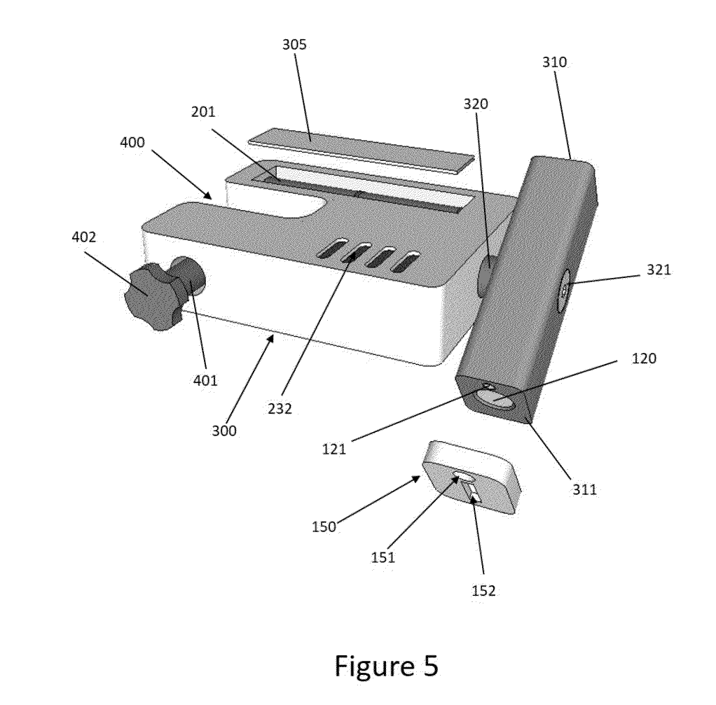

FIG. 5 is a upper perspective view of an apparatus of one embodiment of an apparatus of the present invention wherein the sensor is a proximity sensing (or diffused) photoelectric sensor comprising an emission source (120) and photoelectric receiver (121) positioned in the front face (311) in a sub-housing (310) that is rotatably attached to the main housing (300), the rotation of which is restrained by a screw (321) said main housing (300) housing the alarm system (not shown), power supply (201), the sub-housing (310) being connected to the main housing (300) via a shaft (320), the shaft (320) preferably being hollow to permit internal passage of the electrical wiring from the sensor to the main housing (300). In this embodiment, the main housing (300) provides a recess (400) to receive a baluster (or stair end) and clamping means illustrated here as knob (402) and threaded screw (401) clamp arrangement to provide stable association of the apparatus with the stairway. FIG. 5 also illustrates a focusing mask (150) proving a vertical slit aperture (152) to restrict the field of view of the sensor to a zone close to the plane of the balusters and an aperture In FIG. 5, the mask (150) is shown dissociated from its normal position on the front face (311) of the sub-housing (310) to permit illustration of the components of the sensor. Similarly, the battery door (305) would normally be associated with the housing (300) but is illustrated here as detached to illustrate the power supply (201). The main housing (300) provides a series of apertures (232) to permit emission of sound from the alarm system (not shown) encased in the main housing (300).

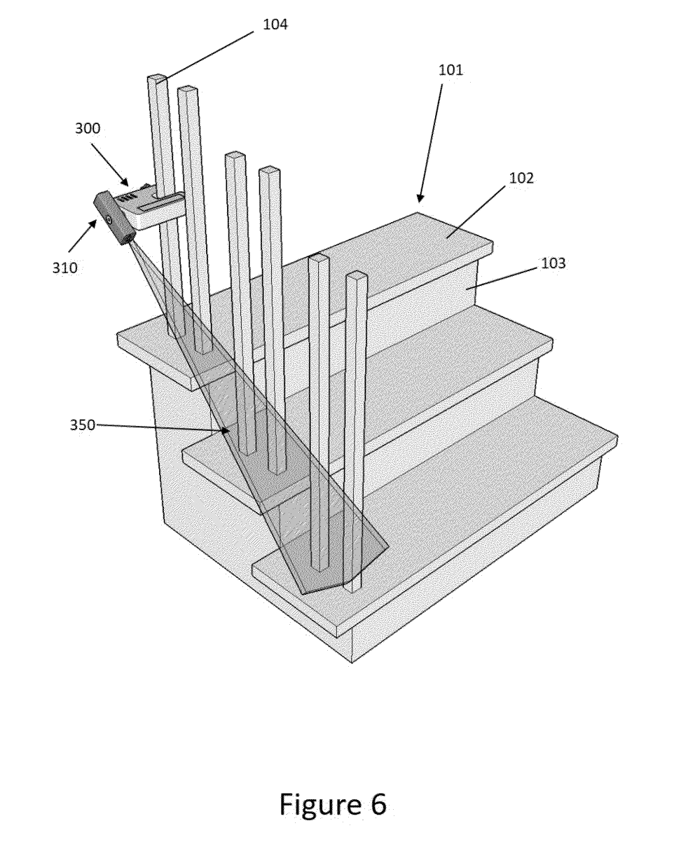

FIG. 6 is a perspective view of an apparatus of the invention as described in FIG. 5 when attached to the balustrade of a stairway (101). As illustrated in FIG. 6, the main housing (300) is stably associated with a baluster (104) using the clamping means illustrated in detail in FIG. 5 and described above. The sub-housing (310) containing the sensor system is rotated to provide a fan shaped planar field of view (350) for the sensor on the outside of the balustrade of the open stairway.

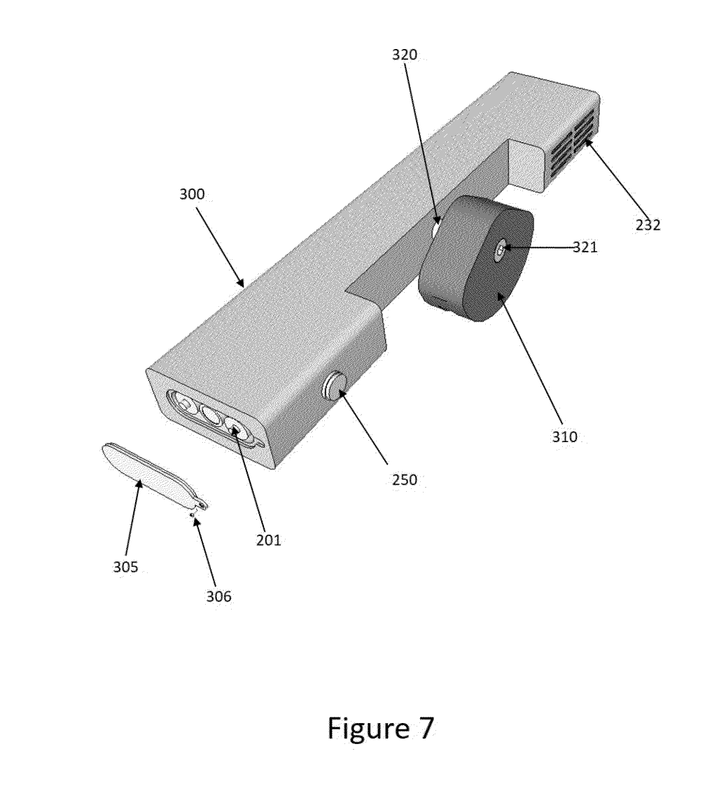

FIG. 7 is an upper perspective view of one embodiment of an apparatus of the present invention wherein the sensor is a passive infrared sensor provided in a sub-housing (310) that is rotatably attached to the main housing (300) the rotation of which is restrained by a screw (321), the main housing (300) encasing the alarm system (not shown), power supply (201), the sub-housing (310) being connected to the main housing via a shaft (320), the shaft preferably being hollow to permit internal passage of the electrical wiring from the sensor main housing (300). The battery door (305) and battery door retaining screw (306) would in normal operation be associated with the housing (300) but is illustrated here as detached to illustrate the power supply (201). The main housing (300) provides a series of apertures (232) to permit emission of sound from the alarm system (not shown) encased in the main housing (300).

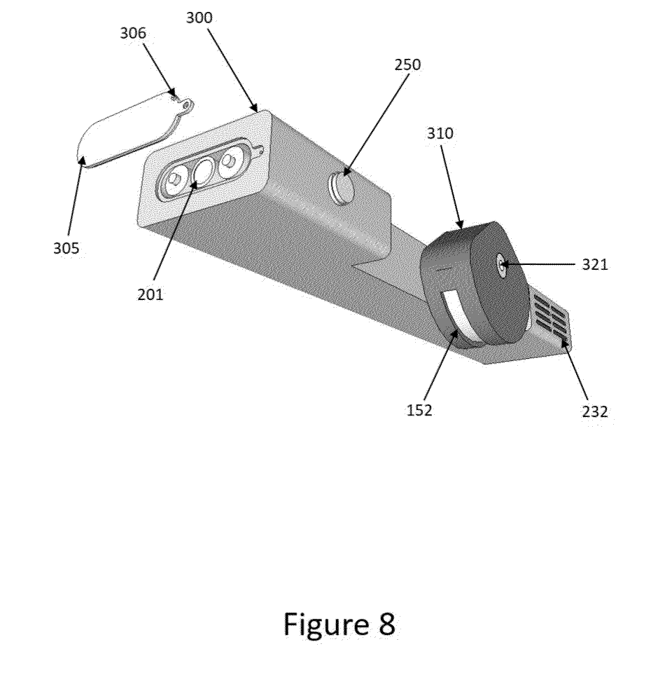

FIG. 8 is an lower perspective view of one embodiment of an apparatus of the present invention wherein the sensor is a passive infrared sensor (not shown) encased in a sub-housing (310) that is rotatably attached to the main housing (300), the rotation of which is restrained by a screw (321), the main housing (300) encasing the alarm system power supply (201), the sub-housing (310) being connected to the main housing via a shaft (320), the shaft preferably being hollow to permit internal passage of the electrical wiring from the sensor to the main housing (300). The battery door (305) and battery door retaining screw (306) would in normal operation be associated with the housing (300) but is illustrated here as detached to illustrate the power supply (201). The main housing (300) provides a series of apertures (232) to permit emission of sound from the alarm system (not shown) encased in the main housing (300). In this embodiment, the sub-housing (310) is configured to incorporate a mask (152) to restrict the field of view of the passive infrared sensor (not shown) encased in the sub-housing (310). Also illustrated in FIG. 8 is a light (250) mounted in the surface of the main housing (300) to indicate power status of the power supply (201)

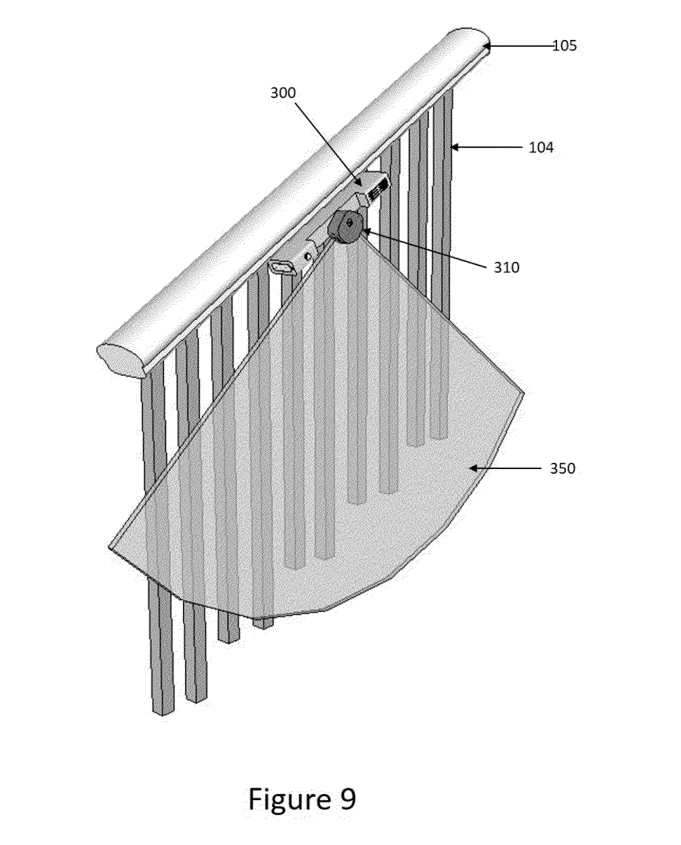

FIG. 9 is an upper perspective view of one embodiment of an apparatus of the present invention as detailed in FIGS. 7 and 8 illustrated in stable association with the on the balustrade. As illustrated in FIG. 9, the main housing (300) of the apparatus is positioned near the handrail (105) and on the outer surface of the balusters (104), the sub-housing (310) encasing the PIR sensor (not shown) is rotated to provide a wide fan shaped planar field of view (350) for the PIR sensor on the outside of the balustrade.

### C. ALARM SYSTEM

The apparatus of the present invention further comprises alarm system. When activated in response to one or more conditions, the alarm system may provide one or more alerts to that notify a human being of one or more hazardous conditions. Such hazardous conditions include but are not limited to: (a) receipt of an electrical signal from a sensor generated in response to a living being present on the outside of an open stairway; (b) lack of, or low, power conditions of the power supply; and/or (c) lack of electrical continuity. Alerts may be achieved by one or more of local alert generators including but not limited to: (a) an audible signal generator (e.g. bell, whistle, or siren) in electrical communication with the alert system and/or (b) a visual signal generator (e.g. flashing light) in electrical communication with the alert system. Alternatively, or in addition to the local alert generators, the alarm system may provide a means to broadcast of an electromagnetic signal (e.g., transmitter) by the alarm system to one or more remote alert devices (e.g. remote receivers capable of producing an alert) including remotely triggered audible signal generators, remotely triggered visual signal generators, cellular telephones or portable computing devices including smartphones, tablets or computers) that are in wireless communication with the system of the present invention. In one embodiment, one of the alerts provided in response to activation of the alarm system is designed to activate a local alert generator that produces a loud audible signal significant to induce distress in a child or animal such that the child or animal is deterred from climbing the outside of the stairway. Examples of such loud audible signals would generally be greater than approximately 80 db, alternatively greater than about 100 db, or alternatively greater than about 120 db.

Examples of means for wireless communication include but are not limited to radio transmitters, telephone communications or wireless communication modules for communication in accordance with protocols such as Wi-Fi™ 802.11 a/b/g/n, Bluetooth®, or cellular data transfer protocols such as GSM®, 3G®, 4G®, LTE® and similar protocols for the wireless transfer of data. For example, the iPhone® series of devices possesses the ability to communicate via cellular connection protocols, Wi-Fi® protocols, and Bluetooth® protocols. In such instances, the alarm system will incorporate electrical components to facilitate such wireless connections such as a radio transmitter, Bluetooth® module, and/or Wi-Fi® module.

The alarm system of the present invention further provides a means for detection of a low power status of the power supply, conventionally involving the actuation of the alarm system to provide an alert to indicate a low power status. Such systems are well known in the art and are conventionally employed in smoke detectors that provide an audible “chirp” alarm to alert the user to a low power status of the power supply. In order to generate this audible chirp in response to a lack of power, the alarm system will conventionally be provided with an auxiliary internal power supply (e.g. battery(ies)) sufficient to provide the alert for lack of power. In general, the actuation of the alert system is achieved when power drops below 40%, alternatively 30%, alternatively 20%, alternatively 10%, alternatively 5% or less of the full charge of the power supply.

In addition to (or in substitution of) the audible power status alert system described above, the system may also provide a visual indication of the power status comprising a meter, one or more lights (LEDs), or the like that provides a visual indication of the power level of the power supply.

The alarm system may be hardwired using conventional electrical components to provide for a variety of alerts in response to system conditions. Alternatively, the alarm system may include a logic controller programmed to produce one or more alerts in response to a variety of conditions. An example of a flowchart of the programming and activation of the logic controller of the alert system is illustrated FIG. 3 of the attached drawings. A block diagram of one embodiment of the present invention incorporating the use of a logic controller, transmitter and remote receiving and remote alert system is illustrated in FIG. 4 of the attached drawings.

### D. POWER SUPPLY

In the practice of the present invention, the sensor is/are in electrical communication with a power supply and an alarm system. The sensor and alarm system are in electrical communication with a power supply. The power supply may be conventional (60 hz/110 A in the USA) AC wall current supplied by conventional wiring to the apparatus. In many instances, it will be desirable to provide a lower power to the apparatus such as when using the pressure sensitive mats that may operate on a lower electrical power than conventional wall current or wireless communication equipment. Additionally, the use of lower power may be a safety feature minimizing the possibility of electric shock. Consequently, a transformer or power adapter may be used to provide appropriate current for the electrical components that are designed to function on lower power.

Alternative to the use of wall current as a power supply, the power supply may be a portable power supply. A portable power supply expands the use of the apparatus of the present invention in those areas where a wired power supply may not be practical (e.g. basements or outdoors). Such portable power supply may comprise one or more batteries. The battery may be non-rechargeable or rechargeable. Examples of batteries useful in the practice of the present invention include zinc-carbon, zinc-chloride, alkaline (e.g., zinc-manganese dioxide), lithium (e.g., lithium-copper oxide, lithium-iron disulfide, lithium manganese dioxide), silver oxide, silver-zinc, NiCd, NiMH, NiZn, lithium ion batteries. The term battery includes a single cell or a plurality of two or more cells. When one or more rechargeable batteries are employed as the power source, the device of the present invention may also be provided with an external charging system appropriate for the particular configuration and specifications of the rechargeable battery employed and the platform providing a plug system for reversible association of the external charging system with the platform containing the rechargeable batteries. The external charging system may also be a solar collector for charging the battery. For purposes of shipment and extended shelf life, there may be an operator-removable physical barrier introduced between the power source and the circuitry of the remainder of the transmission module to preserve the battery power source during storage and shipment and guard against parasitic drain of the battery(ies).

### E. RETENTION MEANS

The apparatus of the present invention further provides for a means to facilitate stable association of the apparatus with the stairway. When the sensor is a pressure sensor such as a pressure sensitive mat, any of a variety of mounting systems may be employed to provide stable association of the pressure sensor with the stairway. For example, the lower portion of the pressure sensor may provide an adhesive on its lower surface that contacts the upper surface of the tread so as to inhibit movement of the pressure sensor once mounted in place on the step. The term “adhesives” is used in it conventional sense to refer to conventional polymeric adhesives including but not limited to semi-permanent adhesives (3M Corporation, Minneapolis Minn.). Reversible stable association may also be achieved through the use of or hook and loop fastener systems (e.g. Velcro®). Such hook and loop fastening means may be employed where the surface of the tread is covered in a fabric material, such as carpet, whereby the hooks are provided on the under surface of the pressure sensitive mat such that they engage the fabric material affixed to the tread surface (the fabric material acting as the loop portion of the hook and loop fastening system) resulting in stable association between the pressure sensor and the fabric covered tread. In one embodiment, the lower portion of the pressure sensor is coated with an adhesive (or provides adhesive tapes) that is protected by a release layer that is removed by the use prior to installation. Alternatively, the pressure sensor may be retained through the use of conventional fasteners (e.g. nails or screws). When using conventional fastening means, the pressure sensor may provide guides for these fasteners to ensure that they do not interfere with the internal electrical components of the pressure sensor. However, as this system is generally in use only when children are small and the user will generally wish to have a system that is removably mounted to the stairway and minimizes damage to the components of the stairway.

In other embodiments such as where the sensor is a photoelectric or passive infrared sensor, the sensor is typically mounted in a position on the stairway or balustrade in a manner to provide sufficient field of view to detect a living being on the outside of the open stairway. Such sensors may be stably associated with the stairway using adhesives, hook and loopfasteners or conventional fasteners as described above. In order to facilitate mounting and demounting of the apparatus from the stairway, the apparatus may be stably associated with the stairway using clamps. In one embodiment as illustrated in FIGS. 5 and 6, the housing containing the components of the apparatus may incorporate a clamping mechanism to achieve stable association between the apparatus and the stairway. Such clampi

### F. METHODS

The present invention further provides a method of providing an alert in response to a living being climbing the exterior of an open stairway, said method comprising employing an retention means to provide stable association to said stairway an apparatus to detect the presence of a living being on the outside of an open stairway said apparatus comprising:
a) a power supply,
b) an alarm system in electrical communication with the power supply said alarm system capable of producing an alert in response to an electrical signal,
c) one or more sensors each of said sensors configured to detect the presence of a living being on the outside of an open stairway, said sensor being in electrical communication with said power supply and said alarm system, such that when the sensor detects a living being on the outside of an open stairway an electrical signal is generated which activates the alarm system that provides an alert.

The present invention further provides a method of deterring a living being from climbing the outside of an open stairway, said method comprising fitting to said stairway an apparatus comprising:
a) a power supply,
b) an alarm system in electrical communication with the power supply said alarm system capable of producing an alert in response to an electrical signal,
c) one or more sensors each of said sensors configured to detect the presence of a living being on the outside of an open stairway, said sensor being in electrical communication with said power supply and said alarm system, such that when the sensor detects a living being on the outside of an open stairway an electrical signal is generated which activates the alarm system that provides an alert wherein said alert is an audible signal greater than 80 db.
   Alternatively, the audible signal is greater than 100 db. Alternatively, the audible signal is greater than 120 db.

### G. KITS

The present invention further provides a kit of parts comprising kit of parts comprising
a) an apparatus, said apparatus comprising:
   i. a power supply,
   ii. an alarm system in electrical communication with the power supply said alarm system capable of producing an alert in response to an electrical signal,
   iii. one or more sensors each of said sensors configured to detect the presence of a living being on the outside of an open stairway, said sensor being in electrical communication with said power supply and said alarm system, such that when the sensor detects a living being on the outside of an open stairway an electrical signal is generated which activates the alarm system that provides an alert.
b) a retention means to provide stable association between said apparatus to a stairway, and
c) instructions for use.
   Instructions may be provided in printed form, compact disc or for retrieval over computer systems such as the internet by providing with the kit an access code or electronic “key”. The kit of parts described above may further provide a stairway safety gate. Stairway safety gates are designed for positioning on a stairway to block access to the inside of a stairway (i.e., the portion of the stairway conventionally used for ascending or descending the stairs). Stairway safety gates are well known in the art and commercially available from a wide variety of suppliers.

I claim:

1. An apparatus to detect the presence of a living being on the outside of an open stairway said apparatus comprising:
d) a power supply,
e) an alarm system in electrical communication with the power supply said alarm system capable of producing an alert in response to an electrical signal,
f) one or more sensors each of said sensors configured to detect the presence of a living being on the outside of an open stairway, said sensor being in electrical communication with said power supply and said alarm system, such that when the sensor detects a living being on the outside of an open stairway an electrical signal is generated which activates the alarm system that provides an alert.

2. The apparatus of claim 1 wherein said sensor is a pressure sensor.

3. The apparatus of claim 2 wherein said pressure sensor is pressure sensitive mat.

4. The apparatus of claim 1 wherein said sensor is a passive infrared sensor.

5. The apparatus of claim 1 wherein said sensor is a photoelectric sensor.

6. The apparatus of claim 5 wherein said photoelectric sensor is a proximity sensing photoelectric sensor.

7. The apparatus of claim 5 wherein said photoelectric sensor is a through-beam photoelectric sensor.

8. The apparatus of claim 5 wherein said photoelectric sensor is a retro-reflective photoelectric sensor

9. The apparatus of claim 1 wherein said sensor is a MFP sensor.

10. The apparatus of claim 1 wherein the alert provided by said alarm system is a is local alert.

11. The apparatus of claim 1 wherein the alert provided by said alarm system is a alarm system broadcasts a signal to a remotely located remote alert device.

12. A method of generating an alert in response to a living being climbing the exterior of an open stairway, said method comprising fitting to said stairway an apparatus to detect the presence of a living being on the outside of an open stairway said apparatus comprising:
a) a power supply,
b) an alarm system in electrical communication with the power supply said alarm system capable of producing an alert in response to an electrical signal,
c) one or more sensors each of said sensors configured to detect the presence of a living being on the outside of an open stairway, said sensor being in electrical communication with said power supply and said alarm system, such that when the sensor detects a living being on the outside of an open stairway an electrical signal is generated which activates the alarm system that provides an alert.

13. The method of claim 12 wherein said sensor of said apparatus provides an audible alert.

14. The method of claim 13 wherein said audible alert is greater than 100 db.

15. The method of claim 12 wherein said alert is a broadcast electromagnetic signal to a remote alert device.

16. The method of claim 12 wherein said sensor is a pressure sensor.

17. The method of claim 12 wherein said sensor is a photoelectric sensor.

18. The method of claim 12 wherein said sensor is a passive infrared sensor.

19. A kit of parts comprising kit of parts comprising
a) an apparatus, said apparatus comprising:
i. a power supply,
ii. an alarm system in electrical communication with the power supply said alarm system capable of producing an alert in response to an electrical signal,
iii. one or more sensors each of said sensors configured to detect the presence of a living being on the outside of an open stairway, said sensor being in electrical communication with said power supply and said alarm system, such that when the sensor detects a living being on the outside of an open stairway an electrical signal is generated which activates the alarm system that provides an alert.
b) a retention means to provide stable association between said apparatus to a stairway, and
c) instructions for use.

20. The kit of parts of claim 19 further comprising a stairway safety gate.
